(19) United States
(12) Patent Application Publication
(10) Pub. No.: US 2025/0111043 A1
(43) Pub. Date: Apr. 3, 2025

(54) METHOD AND SYSTEM FOR DETECTION OF ABNORMAL AUTHENTICATION AND REGISTRATION ATTEMPTS

(71) Applicant: Konica Minolta Business Solutions U.S.A., Inc., Ramsey, NJ (US)

(72) Inventor: Pranay Bhandarkar, Union City, CA (US)

(73) Assignee: Konica Minolta Business Solutions U.S.A., Inc., Ramsey, NJ (US)

(21) Appl. No.: 18/477,794

(22) Filed: Sep. 29, 2023

(51) Int. Cl. G06F 21/55; G06F 21/31

(52) U.S. Cl. CPC G06F 21/552; G06F 21/31; G06F 2221/034

(57) ABSTRACT

A method, a non-transitory computer readable medium, and a computer system that includes a method for detection of abnormal authentication and registration attempts. The method includes receiving, by a computer system, data associated with an authentication or registration on a secured device by a user; scoring, by the computer system, the received data associated with the authentication or registration on the secured device by the user using a machine learning algorithm; and issuing, by the computer system, an alert when the score of the received data associated with the authentication or registration on the secured device by the user exceeds a predetermined score.

### FIELD OF THE DISCLOSURE

The present disclosure generally relates to a method and system for detection of abnormal authentication and registration attempts, and more particularly, to a method and system for detection of abnormal authentication and registration attempts using log analysis using artificial intelligence (AI) benchmarking scores with machine learning (ML) self-scoring techniques.

### BACKGROUND

Multifunction peripherals or multifunction printers (MFP) often require users to login so that the managed print services (MPS) can be implemented. The managed print services can include, for example, user authentication that control identities of users, which can help ensure that users have been authenticated at the MFP before a print job is released and/or printed. In addition, managed print services allow administrators to track and monitor usage in real time through regular, scheduled and on-demand reporting, management, and charge back of costs by assigning users to cost centers, entering of billing or project codes before printing a document. Managed print services can also create print rules or policies, which can help ensure, for example, cost management by allowing different user roles to access different devices and features. For example, duplex printing and/or color printing may be allowed by certain individuals and/or groups and not permitted to other individuals and/or groups.

Unregistered registered users can try to initiate a login attempt to secured device or system, for example, a multifunction printer (MFP), a medical device, access to a secured location, a chemical lab, pharmacy, and the like. Most of the time, the secured device or system is unaware of these attempts and it can be difficult to differentiate whether the attempt is an attack on the secured device or system or simple registration initializing sequence.

Accordingly, it would be desirable to have a method and system that can be detect abnormal authentication and registration attempts on a secured device or system using, for example, AI/ML analyzing and benchmarking techniques.

### SUMMARY

In consideration of the above issues, a method and system are disclosed for detecting abnormal authentication or registration attempts based on log analysis that uses artificial intelligence benchmarking scores with machine learning self-scoring techniques to set a benchmark score for attempts made to a secured device or computer system, and the benchmark scores are analyzed for new login and registration attempts. For example, every time the benchmark score is lower than a predetermined benchmark score or range, an alert can be sent to administrators to analyze the login attempts or registration attempts to help prevent, for example, a cyber-security attack.

In accordance with one aspect, a method is disclosed for detection of abnormal authentication and registration attempts, the method comprising: receiving, by a computer system, data associated with an authentication or registration on a secured device by a user; scoring, by the computer system, the received data associated with the authentication or registration on the secured device by the user using a machine learning algorithm; and issuing, by the computer system, an alert when the score of the received data associated with the authentication or registration on the secured device by the user exceeds a predetermined score.

In accordance with another aspect, a computer program product for detection of abnormal authentication and registration attempts, the computer program product comprising: a non-transitory computer-readable storage medium having program instructions embodied therewith, the program instructions executable by a computer to cause the computer to perform a process, comprising: receiving data associated with an authentication or registration on a secured device by a user; scoring the received data associated with the authentication or registration on the secured device by the user using a machine learning algorithm; and issuing an alert when the score of the received data associated with the authentication or registration on the secured device by the user exceeds a predetermined score.

In accordance with a further aspect, a computer system comprising: a processor configured to: receiving data associated with an authentication or registration on a secured device by a user; scoring the received data associated with the authentication or registration on the secured device by the user using a machine learning algorithm; and issuing an alert when the score of the received data associated with the authentication or registration on the secured device by the user exceeds a predetermined score.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for detection of abnormal authentication and registration attempts on a secure system in accordance with an exemplary embodiment.

FIG. 2 is an illustration of another system for detection of abnormal authentication and registration attempts on a secure system in accordance with an embodiment.

FIG. 3 is an illustration of a process for detection of abnormal authentication and registration attempts on a secure system using log analysis in accordance with an exemplary embodiment.

FIG. 4 is an illustration of a process for detection of abnormal authentication and registration attempts on a secure system using log analysis and machine learning in accordance with an exemplary embodiment.

FIG. 5 is a flowchart for a method for detection of abnormal authentication and registration attempts in accordance with an embodiment.

FIG. 6 is an illustration of an exemplary hardware architecture for an embodiment of a secure system.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

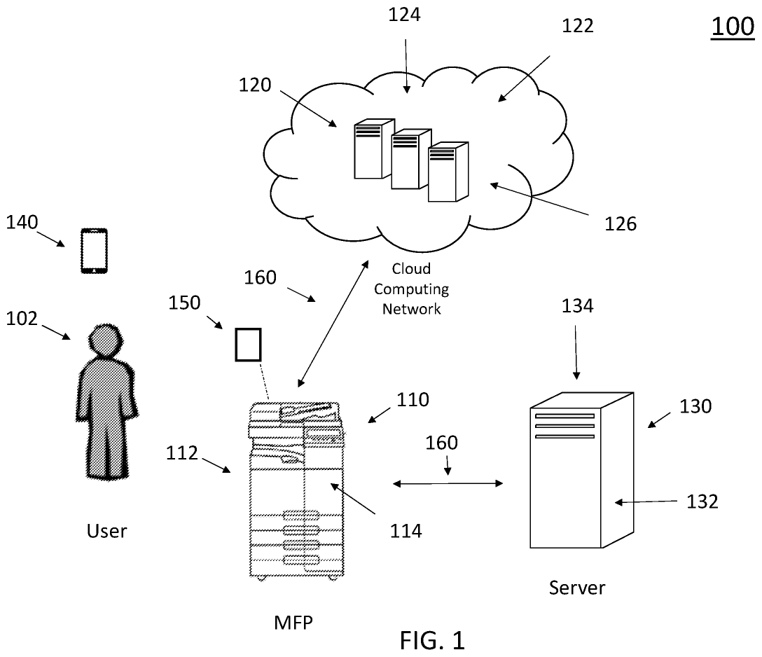

FIG. 1 is an illustration of a system 100 for detecting abnormal authentication or registration attempts on a computer system 110 in accordance with an exemplary embodiment. As shown in FIG. 1, the system 100 can include a computer system 110, for example, a multifunction peripheral or multifunction printer (MFP) 112 and one or more computer systems 120, 130. The one or more computer systems 120, 130 can be configured to host, for example, one or more of managed print services (MPS), a database of authentication, login attempts, and registration of one or more users 102 to the one or more computer systems (or secured devices) 110, 120, 130, authentication, login attempts, and registration of the one or more users 102 for one or more of the managed printer services (MPS), and/or an application or computer software program for detection of abnormal authentication and registration attempts 114, 124, 134 as disclosed herein. The one or more of managed print services (MPS), a database of login and registration of one or more users 102 to one or more of the managed printer services (MPS), and/or an application or computer software program for detection of abnormal authentication and registration attempts 114, 124, 134, for example, the application or computer software program for detection of abnormal authentication and registration attempts 124 can be hosted on a cloud server 122, which can include one or more servers 126.

The system 100 can also include a user 102, and a client device 140 that can authenticate that the user 102, for example, for access to the computer system 110 as disclosed herein. In accordance with an embodiment, the client device 140 can be, for example, a mobile client, for example, a smart phone, a smart tablet, smart watch, or a biometric band that can be used an authentication device, for example, for authentication of the user 102 on the computer system 110. The authentication of the user 102 on the computer system 110 can be, for example, a FIDO authentication workflow for access to the computer system 110, for example, a multifunction peripheral or multifunction printer 112, and managed print services that can be hosted on the computer systems 120, 130. The computer system 110 can be configured, for example, to receive communications from a client device 140 via a near-field communication (NFC) or Bluetooth protocol.

The one or more computer systems 110, 120, 130, and the client device 140 can include a processor or central processing unit (CPU), and one or more memories for storing software programs and data. The processor or CPU carries out the instructions of a computer program, which operates and/or controls at least a portion of the functionality of the devices the one or more computer systems 110, 120, 130, and the client device 140. The one or more computer systems 110, 120, 130, and the client device 140 can also include an operating system (OS), which manages the computer hardware and provides common services for efficient execution of various software programs. For example, the software programs can include application software, for example, for managing an authentication module and/or biometric identifier, and/or printer driver software, for example, for one or more of the computer systems 110, 120, 130, for example, the computer system 110, for example, the multifunction peripheral or multifunction printer 112.

In accordance with an embodiment, the computer system 110 can be a multifunction peripheral or multifunction printer (MFP) 112, which can include at least a copy function, an image reading function, a facsimile (fax) function, and a printer function, and forms an image on a sheet based on a print job multifunction peripheral (print instruction) received, for example, from the computer system 110. The multifunction peripheral or multifunction printer 112 preferably can include a database 150, which hosts an identify of one or more users 102 that can be authenticated, for example, while in a vicinity of one or more multifunction peripherals or multifunction printers 112 as disclosed herein.

The computer system 110 can alternatively, for example, be a medical device or a medical apparatus, which can be used, for example, for diagnostic and/or therapeutic purposes. Examples of medical devices or medical apparatuses can include medical imaging devices, which can obtain, for example, radiological, angiographic, sonographic, and/or tomographic images. Alternatively, the one or more computer systems 110, 120, 130, for example, the computer system 120, 130 can be, for example, a back-end database, or enterprise database system, which can be accessed by the one or more users indirectly through an external application, for example, through the computer system 110.

In accordance with an embodiment, when the computer system 110 is a multifunction peripheral or multifunction printer (MFP) 112, the one or more computer systems 120, 130 as disclosed above, can be configured to host, for example, managed print services (MPS), the database of login and registration of one or more users 102 to one or more of the managed printer services (MPS), and/or an application or computer software program for detection of abnormal authentication and registration attempts 114, 124, 134. For example, the registration of a user 102 can involve a user 102 creating a new account, for example, linked to a biometric, an integrated circuit (IC) card, and the like for access to one or more new managed printer services (MPS). The managed print services (MPS) can include, for example, one or more of user authentication, monitoring and reporting, user and cost management, cost accounting and budget management, printer queue management, and workflow management. For example, user authentication can include control over identities of user, which can help ensure that users have been authenticated at a device before a print job is released and/or printed. The monitoring and report features can allow administrators to track and monitor usage in real time through regular, scheduled and on-demand reporting. The user and cost management feature can help manage and charge back costs by assigning users to cost centers, or enabling them to select the relevant cost center, billing or project code before printing a document. In addition, the user and cost management feature can be used to create print rules or policies, which can help ensure tighter cost management by allowing different user roles to access different devices and features. For example, the user and cost management feature can control, for example, duplex printing and/or color printing to individuals and/or groups. In addition, cost accounting and budget management provides for cost control and flexibility, which can be used as a print management solution that allows administrators to assign print budgets to users, with the option to top up their accounts. For example, in an environment such as a university, for example, this allows administrators to give students a free print quota that they can add to as required. In addition, a print queue management can be used for manage of individual production in addition to office print queues in an office, for example.

The one or more computer systems 110, 120, 130, and the client device 140 can be connected via a communication network 160. The communication network 160 may include, for example, a conventional type of network, wired or wireless, and may have any number of configurations, such as a star configuration, token ring configuration, or other known configurations. The communication network 160 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

Data may be transmitted in encrypted or unencrypted form between the one or more computer systems 110, 120, 130, and the client device 140 using a variety of different communication protocols including, for example, various Internet layer, transport layer, or application layer protocols. For example, data may be transmitted between the one or more computer systems 110, 120, 130, and the client device 140 via the network 160 using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), file transfer protocol (FTP), WebSocket (WS), wireless access protocol (WAP), various messaging protocols (SMS, MMS, XMS, IMAP, SMTP, POP, WebDAV, etc.), or other known protocols.

As shown in FIG. 1, the user 102 can present an authenticator to the computer system 110. The authentication of the user 102 on the computer system 110 can be via, for example, the client device 140 via a near-field communication (NFC) or Bluetooth. For example, the user 102 can be authenticate on the client device 140, which can be, for example, a security identification and authentication device (or authenticator), which uses automated methods of verifying or recognizing the identity of a living person based on a physiological or behavioral characteristic. Thus, the user need not to manually input passwords to the computer system 110, for example, the multifunction peripheral or multifunction printer 112. The method of recognizing the user 102 can include, for example, fingerprints, electrocardiogram (ECG or EKG) information, facial images, iris, and voice recognition. For example, in accordance with an exemplary embodiment, the client device 140 can be a wearable device, for example, a Nymi™ band, which detection of the user 102 is based on the electrocardiogram (ECG) and its unique properties, e.g., electrical activity of the heartbeat of the user (e.g., wearer) 102.

In accordance with an embodiment, authentication via the client device 140 can include the presentation, for example, of mobile device, smart phone, or smart watch of the user 102 to a vicinity of the authenticator (e.g., client device 140) via a near-field communication (NFC) network (e.g., Bluetooth®) and wherein the user 102 has previously been authenticated on the mobile device or smart phone by one or more of a user identifier (ID) and password and/or a biometric identifier, for example, facial recognition, fingerprint, of the like.

In accordance with an exemplary embodiment, the authentication of the user 102 on the client device 140 can be a biometric identifier, which is a distinctive, measurable characteristics used to label and describe or identify an individual, including a metric related to human characteristics. For example, the biometric identifier can include physiological characteristics of an individual including but not limited fingerprints, palm veins, face recognition, DNA (or deoxyribonucleic acid), palm print, hand geometry, iris recognition, retina, and/or odor/scent.

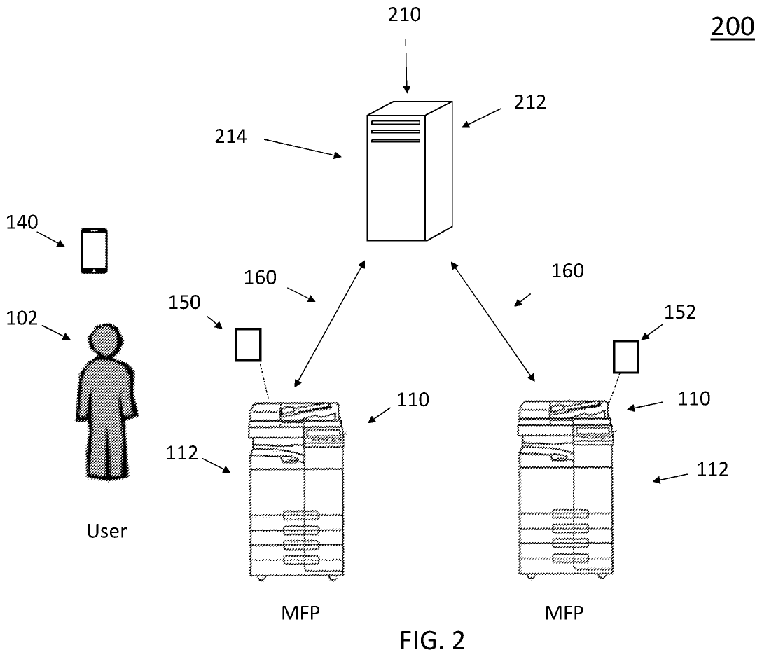

FIG. 2 is an illustration of another system 200 for detecting abnormal authentication or registration attempts on a computer system 110 in accordance with an embodiment. As shown in FIG. 2, the system 200 can include one or more computer systems 110, for example, in the form of a multifunction peripheral or multifunction printer (MFP) 112 that can authenticate a user 102 via a list of authenticated users for each of the one or more computer systems 110. For example, the list of authenticated users 102 for each of the one or more computer systems 110 can be a database 150, 152 that is hosted by the one or more computer systems 110. In accordance with an embodiment,

For example, in accordance with an embodiment, a user 102 can access the one or more computer systems 110 via a mobile application that authenticates the user 102 on the mobile device 140 via an authentication protocol. The user 102 can be authenticated, for example, using a single sign-on (SSO) authentication scheme or protocol. For example, the single sign-on (SSO) authentication scheme or protocol can authenticate the user 102 or digital identity of the user 102 via an identity provider (IdP). As shown in FIG. 2, the computer system 110 receives the request and will forward the authentication request to a computer system 210, which includes a database 212 that logs the authorization and registration attempts for each and every user 102. The database 212 of the authorization and registration attempts can then be used to detect abnormal authentication or registration attempts on the computer systems 110 as disclosed herein.

The computer system 210 can also be an identity provider (IdP) 214 that is configured to store and manage digital identities of one or more users 102. The identity provider (IdP) 214 can check the user's 102 identity via the authenticator, for example, via username-password combinations and other factors including biometric factors. In addition, the identity provider (IdP) 214 can authenticate any entity connected to a network or a system, for example, the computer system 110, 140. In particular, the identity provider (IdP) 214 can be used in a cloud computing environment to manage user identities.

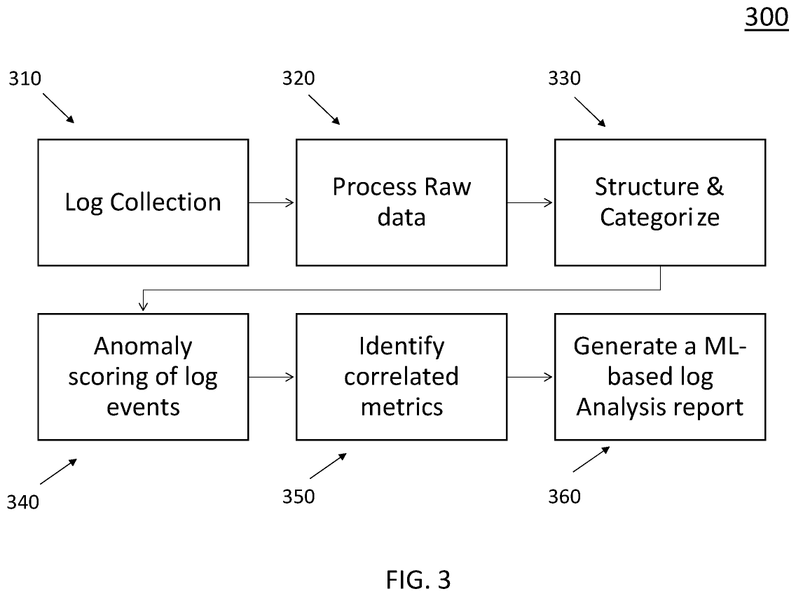

FIG. 3 is an illustration of a process 300 for detection of abnormal authentication and registration attempts on a secure system using log analysis in accordance with an exemplary embodiment. As shown in FIG. 3, the process 300 starts with a collection of data 310 for authentication of one or more users 102 and a registration of one or more users 102 with a computer system 110, 120, 130. For example, the computer system 110, 120, 130 can be a secured device or secured system in which users 102 can be registered, for example, via an authentication protocol. The authentication protocol can include multi-factor authentication, for example, a two-factor authentication process. The logging of the authentication and registration of the one or more users 102 can generate data for every transaction that occurs and every user activity performed in association with not only the authentication and registration process but also any action executed by the one or more users 102 on the computer systems 110, 120, 130.

In addition, the method and system as disclosed herein can also log passive activities of the one or more users 102. For example, the passive activities of the one or more users 102 can include messages, application program interface (API) requests and extra overhead data. For example, the extra overhead data can include any combination of excess or indirect computation time, memory, bandwidth, or other resources that are required to perform a specific task, for example, associated with the authentication or registration of the user 102 with the computer system 110, 120, 130. The registration process can include, for example, creating a new user account for one more users 102 with the one or more computer systems 110, 120, 130 by linking authenticator such as a biometric, an IC card, and the link with the one or more users 102.

In accordance with an embodiment, the log data can be collected from various sources including the one or more computer systems 110, 120, 130, and wherein the one or more computer systems 110, 120, 130 can include hardware and software of servers, applications, and other devices. In accordance with an embodiment, the log data can be stored in a centralized location, such as a log server or a cloud-based service or repository 126, for relatively easy access and analysis. The log data can also be stored, for example, on one or more of the one or more computer systems 110, 120, 130, 210.

In accordance with an embodiment, logs can be automatically generated by the one or more computer systems 110, 120, 130 and each entry in the log will receive a timestamp. The log data can provide detailed information, such as who was part of the event (for example, identity of a user 102), when the event occurred (for example, a timestamp associated with an authentication attempt or registration attempt and any further attempts and related actions), where (for example, location of the computer system or IP address from which the authentication or registration was initiate), and how (for example, via a client device, input of personal identification number, biometric) for each of the one or more computer systems 110, 120, 130.

Once the collection of data (i.e., log collection) 310 has been completed, the collected data 310 is processed so that only the required or necessary information is analyzed and scored. For example, the processing of the raw data 320 from the collection of data can be structured or organized into one or more categorizes of data 330. For example, the one or more categorizes of data 330 can include data associated with the authentication of users 102, the registration of users 102, or a combination of the authentication of users 102 and the registration of users 102, with one or more of the one or more computer systems 110, 120, 130. In accordance with an embodiment, the categories of data can include user names, passwords, time stamps of each and every authentication action and/or registration action, domain users and privileges associated with the user, request for and receipt of one-time passwords via, for example, email on a mobile device or the like, presentation of a personal identification number (PIN) by a user 102, authentication information including biometric information, location of the one or more users 102 via detection of IP addresses, network address and the like from computer systems or mobile devices associated with the one or more users 102 during both the registration and authentication processes. In addition, for example, if the computer system is a secured device in the form of a multifunction printer (MFP) 112 having managed print services, the categorizing of data can include any and all actions associated with the retrieval and/or use of the managed print services.

In accordance with an embodiment, the collection of data can be structured into one or more categories including registration of a user 102, registration of a plurality of users 102, authentication of a user 102, authentication of a plurality of users 102. In addition, the collection of data can be structured into authentication or registration to a specific computer system 110, for example, a multifunction printer (MFP) 112. In addition, the collection of data can be structure into a data associated with a control system of one or more of the computer systems 110, 120, 130, for example, any data associated with the management, commands, directs, or behavior of the among the one or more computer systems 110, 120, 130.

Once the data has been organized into one or more categories of data 330, the process 300 can include anomaly scoring of log events 340 so that actions or processes that deviate from what is standard, normal, or expected can be detected during the authentication and/or registration process of a user 102 and brought to the attention, for example, an administrator, before any damage is done to the computer system 110, 120, 130. For example, when any abnormal behavior of one or more users 102 during an authentication or registration attempt on one or more of the computer systems 110, 120, 130 is detected, a report can be generated to help identify and mitigate any issues that may have arisen from the detected abnormal behavior of one or more users 102 on the one or more computer systems 110, 120, 130.

In accordance with an embodiment, correlated metrics from the anomaly scoring of log events are identified 350, and a machine learning-based log analysis report is generated 360 based on the anomalies.

In accordance with an embodiment, one or more machine learning (ML) techniques can be applied to the processed data to generate a report by scoring the anomalies and deviations from expected workflows. For example, a benchmark score can be devised at the beginning by training the data set 310, which has multiple variations of authentication or registration logs and logs of attacks on the one or more computer systems 110, 120, 130.

In accordance with an embodiment, the generated reports can also include information, for example, where an administrator can identify the bottlenecks (i.e., identification of component that limits the potential of other hardware due to differences in the maximum capabilities of the two components) and hotspots (i.e., a physical location where people can access the Internet, typically using Wi-Fi, via a wireless local area network (WLAN) with a router connected to an Internet service provider that may provide access to an outsider for an unwanted attack) in the one or more computer systems 110, 120, 130, and an extra layer of security can be added in a future version of the authentication or registration process on the one or more computer systems 110, 120, 130.

In accordance with an embodiment, the algorithms for the machine learning can include one or more of the following: linear regression, random forest algorithm, logistic regression, decision tree, SVM algorithm, Naive Bayes algorithm, KNN algorithm, K-means, dimensionality reduction algorithms, and Gradient boosting algorithm, and AdaBoosting algorithm. In addition, the algorithms for the machine learning can be selected from Supervised Learning, Unsupervised Learning, Semi-supervised Learning, and Reinforcement Learning.

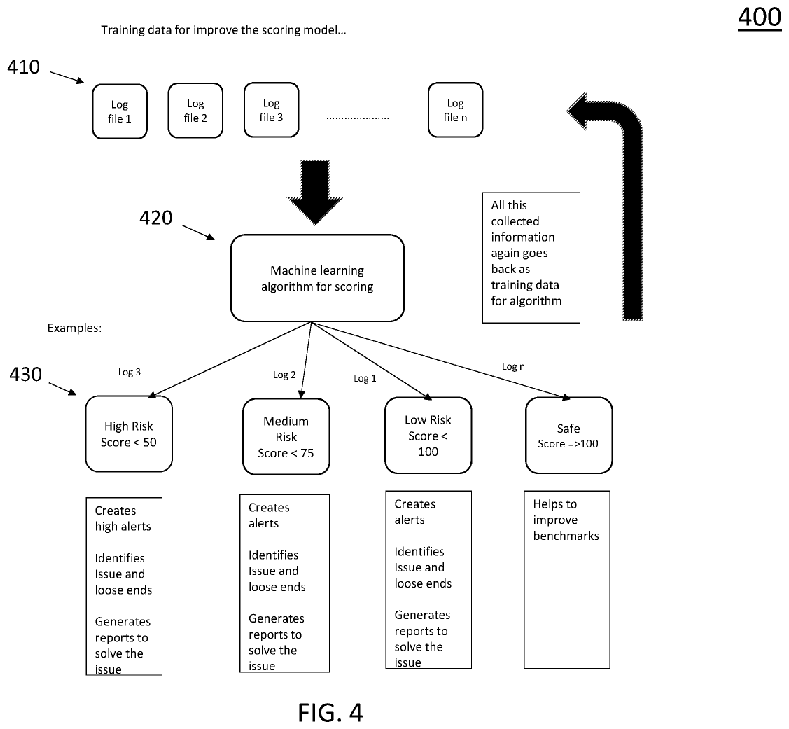

FIG. 4 is an illustration of a process 400 for detection of abnormal authentication and registration attempts on a secure system using log analysis and machine learning in accordance with an exemplary embodiment. As shown in FIG. 4, the process 400 begins with plurality of log files 410. Each of the plurality of logs 410, for example, log file 1, log file 2, log file 3, . . . log file n corresponds to an authentication or registration of a user 102 with a computer system 110, 120, 130, 210. Each of the plurality of log files 410 is input into a machine learning algorithm 420, preferably in realtime, to generate a benchmark score 430 for each of the one or more log files 410. For example, the generated benchmark scores can include “High Risk” (e.g., benchmark score is less than a first predetermined number (e.g., 50), Medium Risk (e.g., benchmark score is less than a second predetermined number (e.g., 75), low risk score (e.g., benchmark score of third predetermined number (e.g., less than 100), and Safe (e.g., benchmark score greater than a fourth predetermined number (e.g., 100).

In accordance with an embodiment, if the benchmark score is in one of categories of High Risk, Medium Risk, or Low Risk, the process 400 can create an alert that can identify issues and/or loose ends, for example, potential risks within the one or more computer systems 110, 120, 130, 210 that need to be addressed, and a report can be created to solve the issues, preferably in realtime so that the identified issues and/or loose ends can be, if necessary, addressed immediately, or addressed in due course. For example, if the benchmark score is classified as a High Risk, the method and system as disclosed herein can immediately take action including, for example, locking an account of a user 102, and/or steps to help prevent an attack on one or more of the computer systems 110, 120, 130, 210.

In addition, if the benchmark score is in the category of Safe, the log data can be used as training data for the machine learning algorithm, which will improve the benchmark scores since all of the collected log data can help train the machine learning algorithm to better understand the authentication and registration habits of users 102 that do not pose a security risk and those habits of users 102 that are anomalies that are not generated by users 102 and are potential security threats. In accordance with an embodiment, examples of log data that can be used to generate an alert can include, for example, multiple attempts by a user 102 to register or authenticate on one or more of the computer systems 110, 120, 130, 210 and based on an analysis of the log file, the multiple attempts can the user 102 can generate a benchmark score that indicates a potential attack or security threat on the one or more computer systems 110, 120, 130, 210, or merely that the user 102 forgot, for example, a password, or the user 102 having difficulty providing an authenticator such as a biometric identifier. For example, the failure to provide a biometric identifier of the user 102 could be as a result of a client device 140 failing to communicate with the one or more computer systems 110, 120, 130, 210 rather than a security risk. In addition, data associated with the authentication or registration of the user 102, for example, frequency of the authentication or registration of the user 102 with the one or more computer systems 110, 120, 130, 210, including a frequency of the user 102 failing to be authenticated and/or being locked out from one or more of the computer systems 110, 120, 130, 210 can be logged by the method and system as disclosed herein and used to help prevent attacks on the one or more computer systems 110, 120, 130, 210. In addition, other actions of the user 102 associated with the authentication of the user 102 can be identified including, frequency of resetting of password or pin a user 102, frequency of changing of password or pin for the user 102.

In accordance with an embodiment, the system 100 can be designed to consider both an individual user 102 and the habits of the individual user 102, and also designed to consider an individual user 102 with a plurality of users 102. For example, the benchmark score generated by the machine learning algorithm for the user 102 may be only based on training data associated with the user 102. Alternatively, the benchmark score generated by the machine learning algorithm may be generated based on the training data associated with a plurality of users 102.

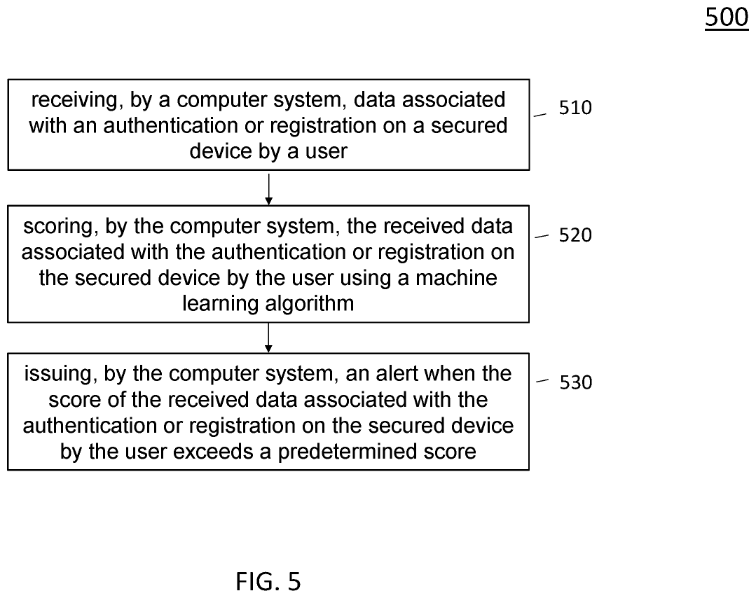

FIG. 5 is a flowchart 500 for a method for detection of abnormal authentication and registration attempts. The method includes: receiving 510, by a computer system 110, 120, 130, data associated with an authentication or registration on a secured device 110, 120, 130 by a user 102; scoring 520, by the computer system 110, 120, 130, 210, the received data associated with the authentication or registration on the secured device 110, 120, 130 by the user 102 using a machine learning algorithm; and issuing 530, by the computer system 110, 120, 130, 210, an alert when the score of the received data associated with the authentication or registration on the secured device 110, 120, 130 by the user 102 exceeds a predetermined score.

In accordance with an embodiment, the method further includes processing, by computer system 110, 120, 130, 210, the data associated with the authentication or registration on the secured device 110, 120, 130 by the user 102 into one or more categories; excluding, by the computer system 110, 120, 130, 210, the data associated with the authentication or registration on the secured device 110, 120, 130 by the user 102 that is not placed into the one or more categories; and scoring, by the computer system 110, 120, 130, 210, the received data associated with the authentication or registration on the secured device 110, 120, 130, 210 by the user 102 using the machine learning algorithm on the one or more categories. The method also includes generating, by the computer system 110, 120, 130, 210, a machine learning-based log analysis report from the scoring of the received data associated with the authentication or registration on the secured device 110, 120, 130, 210 by the user 102. In addition, the method can include generating, by the computer system 110, 120, 130, 210, one or more reports reflecting an analysis of the detection of abnormal authentication and registration attempts based on the scoring of the received data associated with the authentication or registration on the secured device 110, 120, 130, 210 by the user using the machine learning algorithm. For example, the one or more reports can be issued on a daily, weekly, and/or monthly basis for review, for example, by an administrator.

In accordance with an embodiment, the data associated with the authentication or registration on the secured device 110, 120, 130, 210 by the user 102 in the one or more categories can include one or more of username, password, personal identification number (PIN), timestamp of one or more actions associated with the authentication or registration of the user, domain user of the computer system, domain user of an another computer system of the user being used for authentication or registration, authentication information, registration information, location of the computer system, location of the another computer, IP address, or network.

In accordance with an embodiment, the method further includes training, by the computer system 110, 120, 130, 210, the machine learning algorithm with the received data associated with the authentication or registration on the secured device 110, 120, 130, 210 by the user 102. For example, the method can include adjusting, by the computer system, the scoring of the received data associated with the authentication or registration on the secured device by the user using the machine learning algorithm trained with the received data associated with the authentication or registration on the secured device by the user; and issuing, by the computer system, the alert when the adjusted score of the received data associated with the authentication or registration on the secured device by the user exceeds the predetermined score.

In accordance with another embodiment, the method includes generating, by the computer system 110, 120, 130, 210, the issued alert as one or more alerts, the one or more alerts including one or more of an attack on the computer system 110, 120, 130, 210 and an issue to resolve to improve the authentication or registration on the secured device 110, 120, 130, 210 by the user 102.

In accordance with an embodiment, the scoring of the received data associated with the authentication or registration on the secured device 110, 120, 130, 210 of the user with the machine learning algorithm is based on data associated only with the user 102. In another embodiment, the scoring of the received data associated with the authentication or registration on the secured device 110, 120, 130, 210 by the user with the machine learning algorithm is based on data associated with a plurality of users 102.

In accordance with an embodiment, the method further includes collecting, by the computer system 110, 120, 130, 210, data from a plurality of authentications of a plurality of users or a plurality of registrations of a plurality of users; processing, by the computer system 110, 120, 130, 210, the data from the plurality of authentications of the plurality of users or the plurality of registration of the plurality of users into a plurality of log files, the plurality of log files including one or more categories associated with an authentication of a user or a registration of a user; and inputting, by the computer system 110, 120, 130, 210, one or more of the plurality of log files into the machine learning algorithm to train the machine learning algorithm.

In accordance with an embodiment, the secured device 110, 120, 130, 210 can be a multifunction printer (MFP) 112, and the method further includes requesting, by the user 102, managed print services on the secured device 110, 120, 130, 210 or another computer system 110, 120, 130, 210.

In accordance with an embodiment, the method further includes receiving, by the computer system 110, 120, 130, 210, the data associated with the authentication or registration on the secured device 110, 120, 130, 210 by the user from another computer system 110, 120, 130, 210.

In accordance with an embodiment, the data associated with the authentication or registration of the user 102 can include one or more authenticators, the one or more authenticators including an integrated circuit (IC) card, a biometric identifier, a username and a password, and the username and a personal identification number (PIN).

In accordance with another embodiment, the method further includes receiving, by the computer system 110, 120, 130, 210, the data associated with the authentication or registration on the secured device 110, 120, 130, 210 by the user 102 from an identity service provider during authentication of the user 102.

In accordance with an embodiment, the method further includes receiving, by the computer system 110, 120, 130, 210, the data associated with the authentication or registration on the secured device 110, 120, 130, 210, by the user includes a biometric identifier for the user, and the biometric identifier is from a biometric authenticator device associated having one or more of a sensor, a scanning device, or an electronic reader, and the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent.

In accordance with an embodiment, the secured device 110, 120, 130, 210 is a multifunction peripheral or multifunction printer 112, and the method further includes: granting, by the computer system 110, 120, 130, 210, access to managed print services hosted by a service provider external to the multifunction peripheral or multifunction printer 112 when the score of the received data associated with the authentication or registration of the user does not exceed the predetermined score.

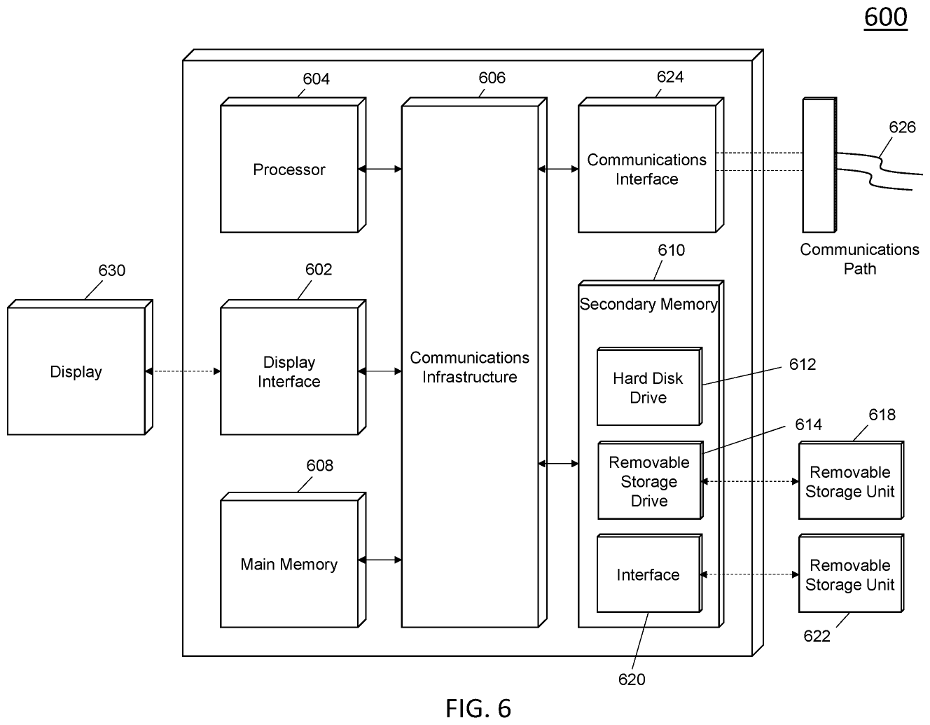

FIG. 6 illustrates a representative computer system 600 in which embodiments of the present disclosure, or portions thereof, may be implemented as computer-readable code executed on hardware. For example, the one or more computer systems 110, 112, 120, 130, 210 or client devices 140 associated with the a method and system for detection of abnormal authentication and registration attempts as disclosed herein may be implemented in whole or in part by a computer system 600 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this representative computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

A processor device 604 may be processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 1-5, as discussed herein. Accordingly, such computer programs may represent controllers of the computer system 600. Where the present disclosure is implemented using software executed on hardware, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software executed on hardware, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detection of abnormal authentication and registration attempts, the method comprising:
receiving, by a computer system, data associated with an authentication or registration on a secured device by a user;
scoring, by the computer system, the received data associated with the authentication or registration on the secured device by the user using a machine learning algorithm; and
issuing, by the computer system, an alert when the score of the received data associated with the authentication or registration on the secured device by the user exceeds a predetermined score.

2. The method according to claim 1, further comprising:
processing, by computer system, the data associated with the authentication or registration on the secured device by the user into one or more categories;
excluding, by the computer system, the data associated with the authentication or registration on the secured device by the user that is not placed into the one or more categories; and
scoring, by the computer system, the received data associated with the authentication or registration on the secured device by the user using the machine learning algorithm on the one or more categories.

3. The method according to claim 2, further comprising:
generating, by the computer system, a machine learning-based log analysis report from the scoring of the received data associated with the authentication or registration on the secured device by the user.

4. The method according to claim 2, further comprising:
generating, by the computer system, one or more reports reflecting an analysis of the detection of abnormal authentication and registration attempts based on the scoring of the received data associated with the authentication or registration on the secured device by the user using the machine learning algorithm.

5. The method according to claim 2, wherein the data associated with the authentication or registration on the secured device by the user in the one or more categories includes one or more of username, password, personal identification number (PIN), timestamp of one or more actions associated with the authentication or registration of the user, domain user of the computer system, domain user of an another computer system of the user being used for authentication or registration, authentication information, registration information, location of the computer system, location of the another computer, IP address, or network.

6. The method according to claim 1, further comprising:
training, by the computer system, the machine learning algorithm with the received data associated with the authentication or registration on the secured device by the user.

7. The method according to claim 6, further comprising:
adjusting, by the computer system, the scoring of the received data associated with the authentication or registration on the secured device by the user using the machine learning algorithm trained with the received data associated with the authentication or registration on the secured device by the user; and
issuing, by the computer system, the alert when the adjusted score of the received data associated with the authentication or registration on the secured device by the user exceeds the predetermined score.

8. The method according to claim 1, further comprising:
generating, by the computer system, the issued alert as one or more alerts, the one or more alerts including one or more of an attack on the computer system and an issue to resolve to improve the authentication or registration on the secured device by the user.

9. The method according to claim 1, wherein the scoring of the received data associated with the authentication or registration on the secured device by the user with the machine learning algorithms is based on data associated only with the user.

10. The method according to claim 1, wherein the scoring of the received data associated with the authentication or registration on the secured device by the user with the machine learning algorithm is based on data associated with a plurality of users.

11. The method according to claim 1, further comprising:
collecting, by the computer system, data from a plurality of authentications of a plurality of users or a plurality of registrations of a plurality of users;
processing, by the computer system, the data from the plurality of authentications of the plurality of users or the plurality of registration of the plurality of users into a plurality of log files, the plurality of log files including one or more categories associated with an authentication of a user or a registration of a user; and
inputting, by the computer system, one or more of the plurality of log files into the machine learning algorithm to train the machine learning algorithm.

12. The method according to claim 1, wherein the secured device is a multifunction printer (MFP), and the method comprises:
requesting, by the user, managed print services on the secured device or another computer system.

13. The method according to claim 1, further comprising:
receiving, by the computer system, the data associated with the authentication or registration on the secured device by the user from another computer system.

14. The method according to claim 1, wherein the data associated with the authentication or registration of the user includes one or more authenticators, the one or more authenticators including an integrated circuit (IC) card, a biometric identifier, a username and a password, and the username and a personal identification number (PIN).

15. The method according to claim 1, further comprising:
receiving, by the computer system, the data associated with the authentication or registration on the secured device by the user from an identity service provider during authentication of the user.

16. The method according to claim 1, further comprising:
receiving, by the computer system, the data associated with the authentication or registration on the secured device by the user includes a biometric identifier for the user, and the biometric identifier is from a biometric authenticator device associated having one or more of a sensor, a scanning device, or an electronic reader, and the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent.

17. The method according to claim 1, wherein the secured device is a multifunction peripheral or multifunction printer, the method further comprises:
granting, by the computer system, access to managed print services hosted by a service provider external to the multifunction peripheral or multifunction printer when the score of the received data associated with the authentication or registration of the user does not exceed the predetermined score.

18. A computer program product for detection of abnormal authentication and registration attempts, the computer program product comprising:
a non-transitory computer-readable storage medium having program instructions embodied therewith, the program instructions executable by a computer to cause the computer to perform a process, comprising:
receiving data associated with an authentication or registration on a secured device by a user;
scoring the received data associated with the authentication or registration on the secured device by the user using a machine learning algorithm; and
issuing an alert when the score of the received data associated with the authentication or registration on the secured device by the user exceeds a predetermined score.

19. The computer program product according to claim 18, further comprising:
processing the data associated with the authentication or registration on the secured device by the user into one or more categories;
excluding the data associated with the authentication or registration on the secured device by the user that is not placed into the one or more categories; and
scoring the received data associated with the authentication or registration on the secured device by the user using the machine learning algorithm on the one or more categories.

20. A computer system comprising:
a processor configured to:
receiving data associated with an authentication or registration on a secured device by a user;
scoring the received data associated with the authentication or registration on the secured device by the user using a machine learning algorithm; and
issuing an alert when the score of the received data associated with the authentication or registration on the secured device by the user exceeds a predetermined score.
